(19) United States
(12) Patent Application Publication
(10) Pub. No.: US 2008/0037374 A1
(43) Pub. Date: Feb. 14, 2008

(54) Portable time display device

(75) Inventors: Chin-Lun Chu, Taichung City (TW); Wen-Fu Yang, Changhua County (TW); Shun-Ming Chang, Taichung City (TW)

Correspondence Address: BIRCH STEWART KOLASCH & BIRCH, PO BOX 747, FALLS CHURCH, VA, 22040-0747, US

(73) Assignee: LEE BOU LABEL ENTERPRISE CO., LTD.

(21) Appl. No.: 11/500,947

(22) Filed: Aug. 9, 2006

(51) Int. Cl. G04C 19/00

(52) U.S. Cl. 368/82

(57) ABSTRACT

A time display device, which is a strip-like member to be wrapped around user's body or other object, includes a flexible circuit board and a flexible case receiving the flexible circuit board therein. The flexible circuit board is provided with a controller and a plurality of hour light emitting devices and minute light emitting devices to indicate hour and minute and two light emitting devices to indicate a.m. and p.m. The case is provided with windows associated with the light emitting devices respectively. The controller controls the predetermined light emitting devices lighting to indicate time.

### BACKGROUND OF THE INVENTION

1. Field of the Invention

The present invention relates generally to a timepiece, and more particular to a portable time display device with novel way to indicate time.

2. Description of the Related Art

Conventional watches have a watchcase and a band. Typically, the watchcase is a round case, and in some cases, there are elliptic or rectangular cases, in which time hands are provided to indicate time. There are digital watches, on the watchcase of which a LCD (liquid crystal display) is provided to show numerals. The band may be wrapped around wrist to wear the watch on it. Such time pieces do not attract consumers anymore.

### SUMMARY OF THE INVENTION

The primary objective of the present invention is to provide a timed display device with novel way to indicate time.

According to the objective of the present invention, a time display device, which may be wrapped around an object, comprises a flexible circuit board and a flexible case receiving the flexible circuit board therein. The flexible circuit board is provided with a controller and a plurality of hour light emitting devices and minute light emitting devices, and the case is provided with windows associated with the hour light emitting devices and the minute light emitting devices respectively. The controller controls the predetermined hour light emitting devices and the minute light emitting devices lighting to indicate time.

### BRIEF DESCRIPTION OF THE DRAWINGS

FIG. 1 is an exploded view of a first preferred embodiment of the present invention;

FIG. 2 is a perspective view of the first preferred embodiment of the present invention;

FIG. 3 is a perspective view of the first preferred embodiment of the present invention, showing the time display device wrapped on wrist;

FIG. 4 is a sectional view along 4-4 line of FIG. 2;

FIG. 5 is a perspective view of the present invention, showing the time display device having a round pattern of time display; and

FIG. 6 is a sectional view of a second preferred embodiment of the present invention.

### DETAILED DESCRIPTION OF THE INVENTION

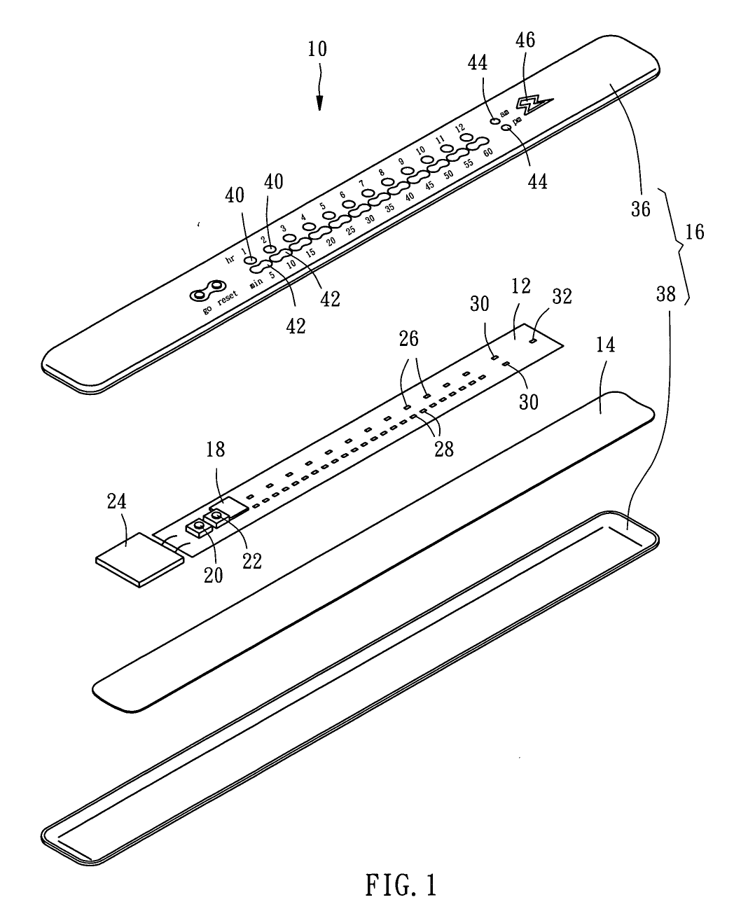

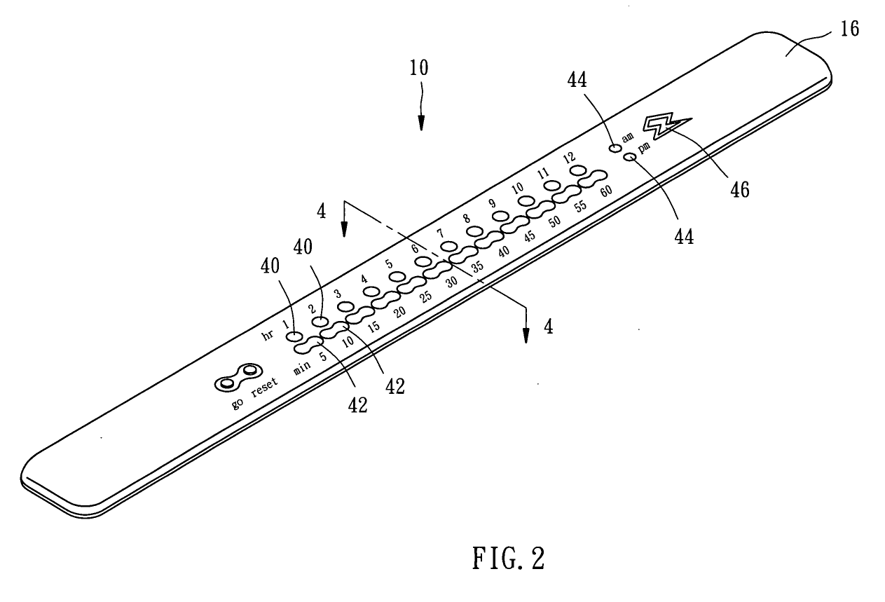

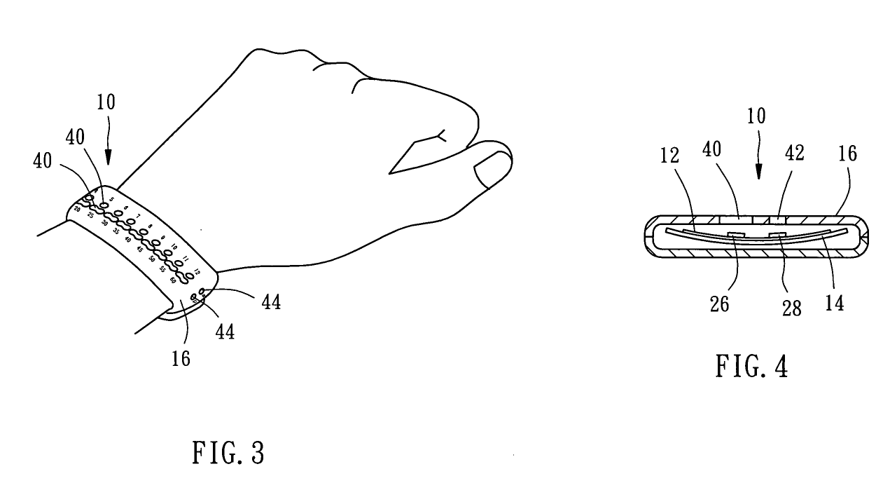

As shown in FIG. 1 to FIG. 4, a time display device 10 of the first preferred embodiment of the present invention includes a flexible circuit board (FCB) 12, a spring plate 14 and a flexible case 16.

The FCB has a predetermined conductor pattern (not shown), a controller 18, two keys 20, 22, a battery 24 and a plurality of light emitting devices 26, 28, 30, 32. The light emitting devices are light emitting diodes (LEDs) in the present invention. Some of the light emitting devices are arranged in two rows, in which the twelve light emitting devices of the first row are defined as hour light emitting devices 26 and the twenty-four light emitting devices of the second row are defined as minute light emitting devices 28. The light emitting devices 30 shows before noon and after noon, and the light emitting device 32 flashes as designation. The battery 24 provides the light emitting devices power. The controller is a microprocessor having a timer and a predetermined circuitry therein to turn on and turn off the specific light emitting devices according to designation.

The FCB 12 is attached on the spring plate 14. In normal condition, the spring plate 14 is wrapped as a ring. User may exert the spring plate 14 to extend it and keep it in straight, as shown in FIG. 4. Any force exerted on the straight spring plate 14 will make it wrapping automatically. The spring plate 14 is a conventional device that readers may find it in many inventions.

The case 16 is made of flexible plastic, such as silicon rubber, which has a space 34 therein to receive the FCB 12 and the spring plate 14 therein. The case 16 has the function of waterproof and electricity-leakage-proof, and the case 16 also provides user with comfortable touch. The case 16 consists of a first piece 36 and a second piece 38. The first piece 36 has a plurality of windows 40, 42, 44, 46 associated with the light emitting devices 26, 28, 30, 32 respectively so that user may see the light of the light emitting devices through the windows. The windows 40 associated with the hour light emitting devices 26 are labeled with numerals of 1 to 12, and the windows 42 associated with the hour light emitting devices 28 are labeled with numerals of 5, 10, 15 . . . and 60. The windows 44 associated with the light emitting devices 30 are labeled with “am” and “pm”, and the window 42 associated with the light emitting device 32 has a thunder pattern.

To wear the time display device 10 of the present invention on user's wrist or other segments or on any column-like member, user may hit the straight time display device 10 on wrist, and the spring plate 14 will wrap around the wrist automatically. All of the light emitting devices 26, 28, 30, 32 of the time display device 10 of the present invention are designated off at initial, and the specific light emitting devices are tuned on when user presses the key 20. For example, if the time is 8:30 a.m., the hour light emitting device 26 associated with numeral 8, the minute light emitting device 28 associated with numeral 30 and the light emitting device 32 associated with “am” are turned on to indicate user the time. The light emitting devices 26, 28, 30, 32 may flash to show a predetermined visual effect when user presses the key that may provide alarm effect in the night or just for fun. It also may be designated that the light emitting devices flash according to a designation of the controller, and then the specific hour and minute light emitting are turned on to indicate time.

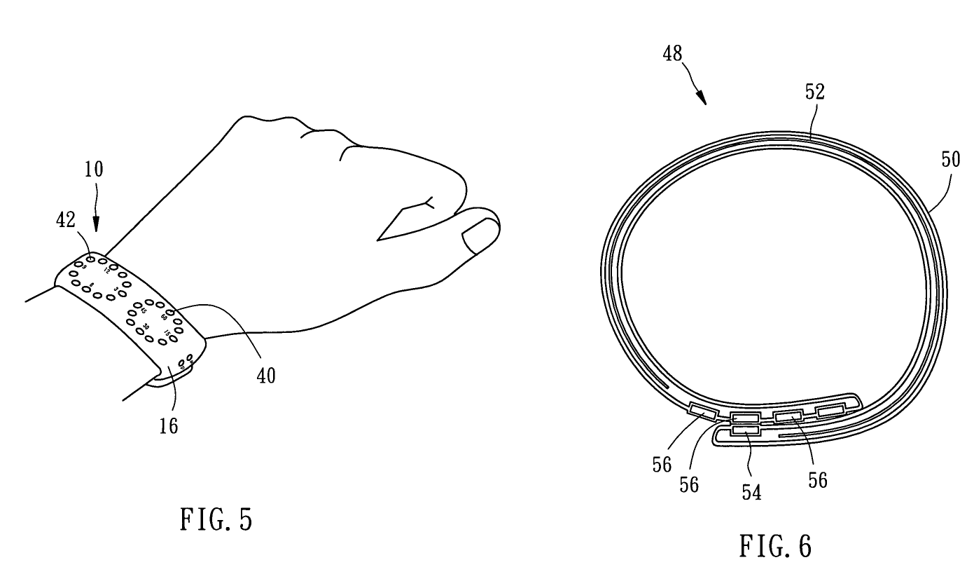

The hour and minute light emitting devices (not shown) may be arranged in two circularities rather than two rows. As shown in FIG. 5, the windows 40 and 42 on the case 16 are arranged in two circularities aligned with the hour and minute light emitting devices. This pattern has space compatibility to user that user may recognize the time by the positions of the lighting hour and minute light emitting devices rather than by identification of the numerals associated with the lighting hour and minute light emitting devices.

FIG. 6 shows a time display device 48 of the second preferred embodiment of the present invention, which is similar to the first preferred embodiment including a flexible case 50 and a FCB 52 with light emitting devices, a battery, a controller and keys thereon, except that the case 50 is provided with magnets 54, 56 on opposite ends thereof. The magnets 54, 56 are embedded in the case 50 when the case 50 is molded. The magnet 54 is provided on an interior side of the case 50, and the magnets 56 are provided on an exterior side of the case 50 and arranged in a line. The magnet 54 may attract any one of the magnets 56 to secure the time display device 48 in circularity with various diameters.

It is noted that any technique to secure the strip-like case to circularity, such as snap fastener, buckle, pin, Velcro or other known fasteners, may be incorporated in the present invention.

What is claimed is:

1. A time display device, which may be wrapped around an object, comprising a flexible circuit board and a flexible case receiving the flexible circuit board therein, wherein the flexible circuit board is provided with a controller and a plurality of hour light emitting devices and minute light emitting devices, and the case is provided with windows associated with the hour light emitting devices and the minute light emitting devices respectively, and the controller controls the predetermined hour light emitting devices and the minute light emitting devices lighting to indicate time.

2. The time display device as defined in claim 1, wherein the hour light emitting devices and the minute light emitting devices are arranged in two rows.

3. The time display device as defined in claim 1, wherein the hour light emitting devices and the minute light emitting devices are arranged in two circularities.

4. The time display device as defined in claim 1, wherein the case is provided with numerals associated with the windows respectively.

5. The time display device as defined in claim 1, further comprising a spring plated received in the case.

6. The time display device as defined in claim 1, wherein the case is provided with magnets on opposite ends.

7. The time display device as defined in claim 6, wherein the magnets are arranged in a line.

8. The time display device as defined in claim 6, wherein the flexible circuit board is provided with at least a light emitting device, and the case is provided with a window associated with the light emitting device, and the controller controls the light emitting device lighting or flashing.

9. The time display device as defined in claim 1, wherein the flexible circuit board is provided with at least two light emitting device, and the case is provided with two windows associated with the light emitting devices respectively and labeled with characters indicating before noon and after noon.

10. The time display device as defined in claim 1, wherein the case receives the flexible circuit board therein in a waterproof condition.

11. The time display device as defined in claim 1, wherein the case is made of an insulating material.

12. The time display device as defined in claim 1, wherein flexible circuit board is provided with a key, and the light emitting devices are turned on when the key is pressed.

13. The time display device as defined in claim 1, wherein flexible circuit board is provided with a key, and the light emitting devices flash according to a designation of the controller, and then the specific hour light emitting device and the minute light emitting device are turned on to indicate time when the key is pressed.
